(19) United States
(12) Patent Application Publication
(10) Pub. No.: US 2008/0113323 A1
(43) Pub. Date: May 15, 2008

(54) Learning/Play Quilt for development of toddlers' fine motor skills (dexterity): zipping, tying, buttoning, lacing, snapping, hooking, use of Velcro, buckling, and identification of numbers, letters, words and containing pockets for storing small toys in addition to being used as a blanket

(76) Inventor: Janice Sweet McElhoe, State College, PA (US)

Correspondence Address: Janice Sweet McElhoe, 673 Crandall Drive, State College, PA, 16803, US

(21) Appl. No.: 11/594,458

(22) Filed: Nov. 9, 2006

(51) Int. Cl. G09B 19/24; G09B 19/00; A63H 33/00

(52) U.S. Cl. 434/260; 434/258; 446/26

(57) ABSTRACT

The Learning/Play Quilt or Denim/Learning Play Quilt is a compilation of components of children's clothing sewn together to facilitate development or practice of fine motor skills (dexterity) such as zipping, buttoning, lacing, tying, snapping, hooking, use of Velcro, and buckling. The quilt format provides an extensive selection of fine motor skills not found in other formats such as books, vests, dolls and mats, and, at the same time, provides utilitarian uses as a cover for the child in a car seat or stroller. It also features pockets for storage of small toys and treasures. The components of children's clothing also expose children to numbers, letters and words while the embroidery thereon creates a product that is attractive and, therefore, promotes the child's interest in learning. The recommended lap quilt size predisposes its use to places where supervision is more readily available then if used on a bed. This is not only a safety feature but one in which more peer and adult interaction can occur.

### CROSS-REFERENCE TO RELATED APPLICATIONS

Educators, parents and toy-makers have found that a quilt/blanket/mat provides a format for developing many skills, however, according to my search, the fine motor skills, including dexterity and eye-hand coordination, have heretofore been presented in other formats such as dolls, vests, etc.

U.S. Pat. No. 6,427,265 to Julie, for example, uses an interactive blanket and pillow with a plurality of spaced-apart ribbon loops with tags provided in a variety of colors, patterns, and textures as a means for providing sensory stimulation for children via the children's passive (ocular) or active (tactile) interaction with the pillow or blanket.

### This invention facilitates development of early childhood skills through use of the blanket format but has little to do with the development of dexterity.

U.S. Pat. No. 5,540,609 to Barbara uses the format of a quilt and associated set of dolls to develop stories with children. Each panel of the quilt illustrates a particular scene, in similar fashion to a conventional story board. Creating stories involves important skills but in this case does not include development of fine motor skills.

U.S. Pat. No. 6,233,763 to Susan uses a blanket with pockets and buttons for retaining amusement figures and the like. Any development of dexterity in this patent is coincidental.

U.S. Pat. No. Des. 393,877 to Jean-Paul uses a mat for the early learning of babies. It features an ornamental design that stimulates babies but does not develop eye/hand coordination.

U.S. Pat. No. 3,546,789 to Joel is an educational multiple doll-like nested set where the dolls decrease in size and the fastening tasks require greater dexterity as the dolls become smaller. The doll format does facilitate development of fine motor skills: zippers, snaps, buttons and lacing. There is not the plurality of fine motor skills that are found in my Learning/Play Quilt and the tasks do not provide life size dexterity experiences similar to those found on a toddlers' garments in the real world. In addition, it does not provide the advantages of a blanket.

U.S. Pat. No. 5,746,639 to Stuart is a stuffed doll and clothing combination. The fastening skill is hook and loop. The fine motor skill of fastening is coincidental and the invention not specifically designed to facilitate learning dexterity.

U.S. Pat. No. 4,637,798 to Mary discloses a doll which is useful for teaching the child to count from 1 through 10, useful for teaching the child to identify colors, and useful to familiarize the child with various wearing apparel fasteners. The doll facilitates the learning of five fine motor skills: buttons, snaps, a zipper, one shoe buckle, shoe laces and a bow to tie. The doll does not provide life size dexterity experiences and it does not have the other utilitarian uses provided by the Learning/Play Quilt.

U.S. Pat. No. 4,273,539 to Glenn is a training toy for helping children learn how to lace their shoes and also to enhance or improve their fine motor skill (eye/hand coordination). This is an example of an appropriate aid for children learning one, but only one, fine motor skill. My Learning/Play Quilt provides a plurality of fine motor skills and can be used in other utilitarian ways.

U.S. Pat. No. 3,638,334 to Ethel is a garment, vest or trouser front, for assisting in teaching persons to fasten articles of clothing. Specifically, matching colors, buttons and buttonholes and contrasting zipper elements are provided. These vests, called Manual Dexterity Vests can be bought at Sammons Preston. The elements are life size and, therefore, the skills are easily transferable to real life clothing, but only two fine motor skills are developed, i.e. buttoning and zipping. Also, they cannot serve as blankets.

Other educational tools are available to aid in the development of fine motor skills (dexterity) in early childhood. Several books are available at Web site “Just for Kids”, October 2006, http://www.just-for-kids.com. One book entitled “I Can Get Dressed” helps children practice tying a ribbon, buckling a belt, and buttoning a jacket. Another book entitled “Helpful Shoelace” comes with a real shoelace to lace and tie. In “Get Ready, Eddie” a working snap, button, and zipper allow toddlers to practice their own dressing skills. These books provide a smattering of fine motor skills but do not provide the other utilitarian aspects of the Learning Quilt. Baby Learning Quilt Blocks can be found at http://www.secretsof.com, October, 2006. They help kids learn colors and shapes but do nothing to teach fine motor skills.

Some of the cross-referenced educational tools referenced above do facilitate development of fine motor skills but all are limited in the number of skills actually practiced. My learning quilt/blanket provides many additional opportunities for development of fine motor skills.

In addition, my lap quilt has long term utility beyond learning. It can be used as a lap quilt to cover and entertain the child in the car seat or stroller or as a blanket. It is durable and can be used at the beach or on the floor at home. The many pockets provide storage for tiny toys and treasures. Toddlers also are exposed to numbers, letters and words that are part of the quilt patches.

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

The Learning/Play Quilt relates to the development of fine motor skills (dexterity) in early childhood. Fine motor skills include the ability to manipulate small objects requiring involvement of the smaller muscle groups. Dexterity enables children to become independent when dressing, i.e. putting on or taking off clothing. The manipulation of buttons, laces, ties, zippers, Velcro, snaps, buckles and hooks are characteristics found in articles of clothing. This invention is a compilation of components of children's clothing put together to create a learning/play quilt. These components are readily found in toddler denim garments and, therefore, the use of denim is recommended as a durable fabric. In this case the title of the quilt would be Denim Learning/Play Quilt.

### BRIEF SUMMARY OF THE INVENTION

The Learning/Play Quilt is a compilation of components of children's clothing to facilitate learning and practice of the fine motor skills required for dressing and in other areas of life such as buttoning, lacing, tying, zipping, use of Velcro, snapping, buckling and attaching hooks. Exposure to these skills can be found in other toys and educational tools such as books, vests, dolls and mats. However, exposure to the fine motor skills is limited in all products that I have found. The quilt that I have designed brings together additional features that are a part of the clothing from which the quilt is made including exposure to numbers, letters and words. It also has a myriad of pockets for storage of small toys and treasures. Utilitarian uses include covering the child in the car seat or stroller or using as a blanket at the beach or at home. The characterization that is part of the embroidery found on toddler clothing will promote the child's interest in learning. I would hope to sell this patent to a company that produces denim clothing where they would already hold patents for the embroidery work such as Disney or Sesame Street.

### BRIEF DESCRIPTION OF THE SEVERAL VIEWS OF THE DRAWING

FIG. 1

The Learning/Play quilt will have three layers: a top quilt base 1, filler layer of quilt batting 2, and a backing that is folded over at the edges and stitched to the front as a border 3. The three layers will be held in place through a process of machine or hand quilting 4.

FIG. 2

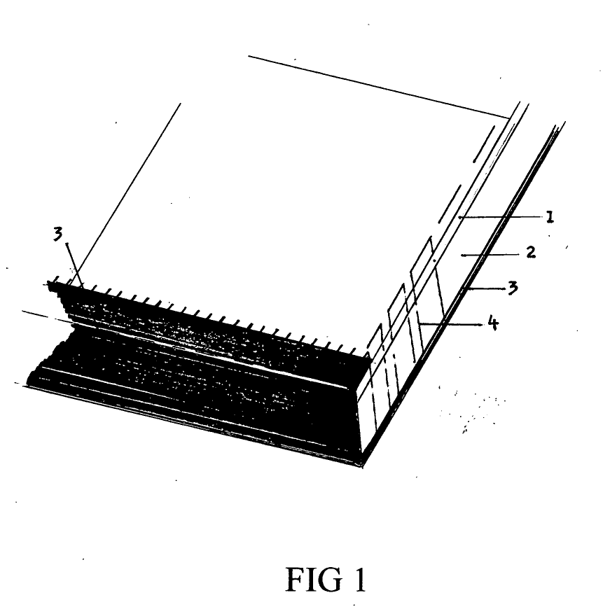

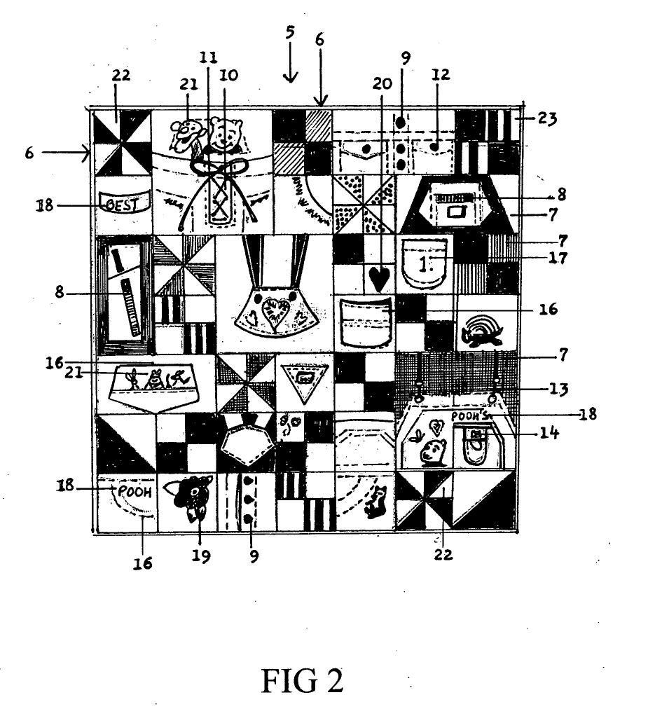

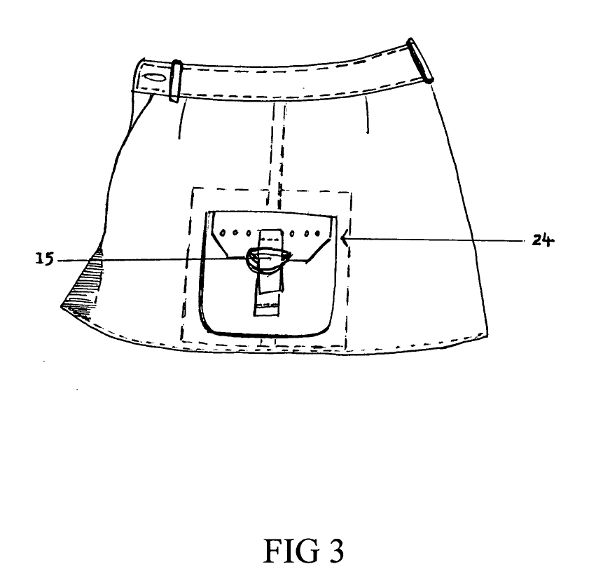

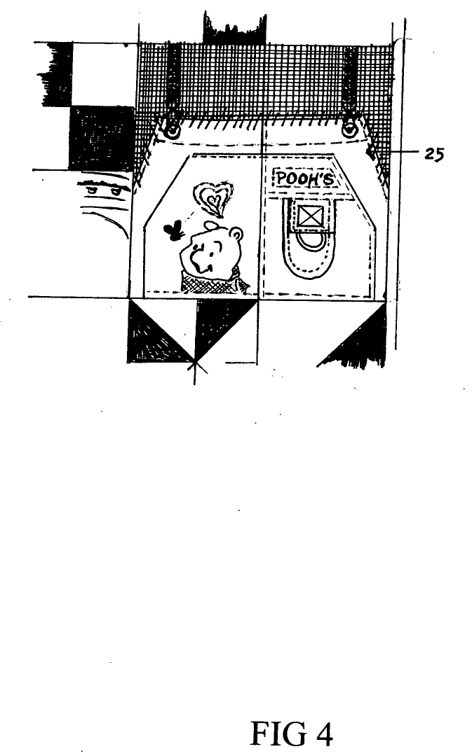

The drawing of the quilt base is an example of design that may be modified 5, however, use of manipulative skill opportunity must be maximized in any design. The suggested size will be approximately 36″×36″6, although a larger quilt is possible. The finished quilt base will be constructed from patches that measure about 5.5″ square, 5.5″×11″ or 11″ square 7. The patches will provide learning and practice of fine motor skills such as zipping 8, buttoning 9, lacing 10, tying 11, snapping 12, hooking 13, and use of Velcro 14 and buckling 15. Other patches will provide pockets 16. Some may also provide exposure to numbers 17, letters and words 18. Patches containing embroidery such as flowers 19, hearts 20, and storybook characters 21 will increase the desirability of the quilt. The remainder of the patches will be traditional patterns such as pin wheel 22, and four-square 23.

FIG. 3

The patches will be cut from actual children's clothing 24 (or from overruns that were created for the purpose of clothing construction or clothing designs that were manufactured solely for this Learning/Play quilts).

FIG. 4

Use of the bib from bib overalls will require appliqué of the bib to an 11″×11″ square, wherever it is not part of the salvage 25.

### DETAILED DESCRIPTION OF THE INVENTION

A motor skill embodies to the ability of an organism to utilize skeletal muscles effectively. Most motor skills are learned in early childhood. Fine motor skills include the ability to manipulate small objects, transfer objects from hand to hand, and coordinate hand-eye tasks. Fine motor tasks require precise motor movement to achieve delicate tasks. Fine motor development refers to the development of skills involving the smaller muscle group and includes using the pincer grasp (thumb and forefinger) to pick up or manipulate small objects. The development of the fine motor skills (dexterity) is required for toddlers to begin dressing and undressing themselves. They must learn to zip zippers, button buttons, snap snaps, lace shoes, tie bows, close Zelcro strips, buckle buckles, and hook one part of the clothing to another.

This invention is a Learning/Play Quilt for Development of Toddler's Fine Motor Skills (dexterity): Zipping, Buttoning, Lacing, Snapping, Hooking and Buckling. Denim is recommended for construction of the Learning/Play Quilt. If denim if used then the title should include the word denim, i.e. Denim Learning/Play Quilt . . . Denim fabric is a very popular choice for children's garments, and therefore, components of toddler garments are readily available. Denim is also a durable fabric.

A prototype for this invention was constructed from used toddler clothing bought at thrift stores. A larger manufacturer might use overruns or increase production of certain components designed for toddler clothing. The resulting compilation will include material to which copyright has already been claimed, in particular embroidery of childhood designs and insignia, i.e. Disney, Sesame Street, etc. Any manufacturer of the Learning/Play Quilt will use the designs/insignia for which they hold the patent.

The Learning/Play Quilt will have three layers: a top quilt base, a one piece layer of quilt batting and a back consisting of one piece of cloth similar to the fabric used in the top quilt base that is folded over and stitched to quilt base to form a border. The three layers will be machine or hand quilted to hold them in place.

The top quilt base design can be modified to use the clothing components available but must maximize the fine motor skill development opportunities. A lap quilt size is recommended such as 36″×36″ with finished patches of 5.5″ square, 5.5″×11″ and 11″×11″. However, a larger or smaller quilt is a possibility. Patches will provide an opportunity to practice or develop fine motor skills including zipping, buttoning, lacing, tying, snapping, hooking, and use of Velcro. Other patches will provide pockets for storing small toys or treasures while some may provide exposure to numbers, letters and words. Patches containing embroidery such as flowers, hearts and storybook characters will increase the attractiveness and desirability of the quilt. The remainder of the patches will be traditional quilt designs such as pin wheel and four square.

The patches will be cut from actual toddler clothing or accessed from overruns or created from designs that were manufactured solely for this Learning/Play Quilt. Some patches, mainly those from bib overalls will require application of the bib to an 11″×11″ patch wherever it is not part of the salvage edge of the patch. All patches will be of similar fabric and pieced together by hand or machine.

This Learning/Play quilt is different from all other quilts because it provides opportunities to practice and/or develop the fine motor skills (dexterity) required to dress and undress. It is also different from other quilts because the size predisposes the use of the quilt to be in situations where closer supervision is available rather than on a bed. This is not only a safety feature but an opportunity for more interaction with peers and adults.

This quilt is different from cross-referenced manipulatives discussed in [0012] because it provides many more examples of fine motor skills per item. It can also be used for multiple additional purposes such as covering the child in a car seat or stroller while simultaneously providing entertainment and learning opportunities. It is made from durable materials and can, therefore, be used at the beach, on picnics or at home on the floor.

1. The compilation of components of children's clothing (preferably denim) sewn together to create a learning/play quilt to facilitate development and practice of many childhood fine motor skills (dexterity)
including zipping, buttoning, lacing, tying, snapping, hooking, use of Velcro, and buckles,
with multiple pockets for storing small toys and treasures,
to be used alternatively as a blanket or lap cover,
as shown and described.
